(19) United States
(12) Patent Application Publication
(10) Pub. No.: US 2001/0045371 A1
(43) Pub. Date: Nov. 29, 2001

(54) Portable waste receptacle

(76) Inventor: Andrew Ordonez, Oxnard, CA (US)

Correspondence Address: Arthur K. Samora, Kenneth J. Hovet Law Offices, Suite 601, 4476 Market Street, Ventura, CA, 93003, US

(21) Appl. No.: 09/828,571

(22) Filed: Apr. 5, 2001

Related U.S. Application Data
(60) Provisional application No. 60/194,771, filed on Apr. 5, 2000.

(51) Int. Cl. A47L 13/52; B08B 7/00; B65D 21/00

(52) U.S. Cl. 206/499; 15/257.1; 15/257.6; 134/6; 220/908

(57) ABSTRACT

A portable waste receptacle in accordance with the present invention includes a bottom and a front wall, a pair of opposing receptacle side walls and rear wall. Each of the walls project upwardly from the bottom and define the interior of the receptacle. The back wall is formed with a flat top portion and had an increasing taper from an initial width at the rear wall midsection to a maximum width at the top leading edge of the rear wall upper section. The top leading edge is further beveled to facilitate placement of debris in the receptacle when the rear wall is placed on the ground. The receptacle includes a removable lid that has a base, and a pair of opposing lid side walls and rear end portion that extend from the base to establish a scoop configuration for the lid. A lip extends around the receptacle side walls and front wall of the receptacle, and the lid abuts an internal shoulder in the lip when the lid is placed on the receptacle.

This application claims priority from provisional patent application No. 60/194,771 which was filed Apr. 5, 2000.

### FIELD OF THE INVENTION

The present invention pertains generally to waste receptacles. More specifically, the present invention pertains to waste receptacles that are formed with an integral dustpan portion to facilitate the cleanup of trash and debris.

### BACKGROUND OF THE INVENTION

Waste receptacles are well known in the prior art for retaining trash, debris and the like. The receptacle provides a convenient storage of trash and provide increased the convenience for the user by facilitating the removal of trash.

There are a few inconveniences, however, that are associated with receptacles. Specifically, it is sometimes required to first sweep debris into a dustpan, and then dump the dustpan into the receptacle. In the case of larger debris, such as yard waste/leaves, the receptacle is typically placed next to a pile of yard waste/leaves. Next, the worker bends over, picks up a handful of leaves, straightens up and places the leaves in the receptacle. This sequence is repeated until the yard waste/leaves has been placed within the receptacle.

The above sequence is very inefficient and time-consuming for several reasons. First, it is difficult for the worker to grab a large volume of yard waste/leaves with bare hands. Second, yard waste/leaves often spill from the worker's hands during the transfer from the pile to the receptacle, which often requires further re-gathering of the yard waste/leaves into a pile for transfer into the receptacle. Even more important, the worker can incur a work related injury as a result of the excessive, repeated bending motion described that is required to place debris in prior art receptacles.

When the worker lays the receptacle down on its side, the process is still inefficient. This is because the receptacle is typically rounded and is unstable, which cause the receptacle to move as it is filled. Other times, a permanently mounted lid hinders the placement of yard waste within the receptacle. To increase the efficiency of the process, the worker often finds a makeshift “scoop” tool and uses the scoop to increase throughput of yard waste into the receptacle. But the makeshift scoop, however, is often poorly designed and is not much more efficient than the worker's hands.

U.S. Pat. No. 4,802,258, which issued to Jensen for an invention entitled “Combination Dustpan and Guide Means For Filling Trash Containers And The Like”, discloses a dustpan having a scoop portion and a rear handle that can be removably attached to a trash can. Jensen, however, does not disclose a receptacle with a wall portion that is flattened and flared outwardly, nor does Jensen disclose a lid that rests on an internal shoulder of the receptacle and that is shaped to function as a scoop to facilitate placement of yard waste/leaves into the receptacle.

U.S. Pat. No. 3,346,271, which issued to Parsons for an invention entitled “Nestable Cart of Molded Material”, discloses an angled rear surface wall. Parsons, however, discloses a rear surface wall which is uniform in width and which is not flared. Parsons further fails to recite any beveling of the top edge of the rear wall to facilitate the placement of debris within the receptacle while the receptacle is laying on its side to receive the debris. Further, Parsons does not discuss a lid that rests on an internal shoulder of the receptacle and that is shaped to function as a scoop.

In view of the above, it is an object of the present invention to provide a portable waste receptacle which is configured to simultaneously function as both a receptacle and as a dustpan. It is another object of the present invention to provide a portable waste receptacle that facilitates the placement of waste and/or debris within the receptacle without the use of a dustpan. It is another object of the present invention to provide a portable waste receptacle with a removable lid which is configured to function as a scoop to facilitate the placement of debris in the receptacle. Yet another object of the present invention is to provide a portable waste receptacle that is easy to use and that can be manufactured in a cost-efficient manner.

### SUMMARY OF THE INVENTION

A portable receptacle in accordance with the present invention includes a bottom from which extends a front wall, a rear wall and two receptacle side walls. The bottom, front wall, receptacle side walls and rear wall combine to define an interior for the receptacle, and the rear wall flares outwardly from about the mid-section of the rearwall to an upper section of the rear wall.

A flat top portion is formed in the upper section of the rear wall to establish a dustpan-like configuration for the top portion. For this purpose, the rear wall has an increasing taper from an initial width at the midsection to an upper section width that is greater than the initial width. The upper section terminates at a beveled edge which lies flat against the ground when the receptacle is tilted and the rear wall is resting against the ground. The beveled edge further facilitates the placement of dust, trash, debris and the like into the receptacle when the receptacle is positioned for operation as described above.

To facilitate the placement of debris therein, the receptacle of the present invention further includes a removable lid. The lid has a base, and a pair of opposing lid side walls and rear end portion that extend upwardly from the base to form a scoop-like configuration for the lid. For placement on the receptacle, the lid is placed on the receptacle so that the rear end portion and lid side walls abut an internal shoulder which is formed in the lip of the receptacle. The lid can also be hingedly mounted on the receptacle, if desired, provided the lid can be selectively removed for use as described above.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is a side elevational view of the waste receptacle and lid of the present invention.

FIG. 2 is an isometric underside view of the lid of the receptacle shown in FIG. 1.

FIG. 3 is a front elevational view of the waste receptacle shown in FIG. 1 with the lid removed.

FIG. 4 is a rear elevational view of the waste receptacle shown in FIG. 3.

FIG. 5 is a top plan view of an alternative embodiment of the waste receptacle shown in FIG. 3.

FIG. 6 is an enlarged fragmentary cross-sectional view of the receptacle lip taken along line 6-6 in FIG. 5.

FIG. 7 is an enlarged fragmentary cross-sectional view taken along line 7-7 in FIG. 5.

FIG. 8 is a side elevational view of a stacked plurality of the waste receptacles and lids shown in FIG. 1

FIG. 9 is an enlarged fragmentary cross-sectional view of the rear wall upper section and lid which shows an alternative embodiment for the lid and the upper section.

FIG. 10 is the same view as FIG. 9 but with the key post of the upper section aligned with the key slot of the lid.

FIG. 11 is the same view as FIG. 9 with but the lid hingedly connected to the upper section.

### WRITTEN DESCRIPTION OF THE PREFERRED EMBODIMENTS

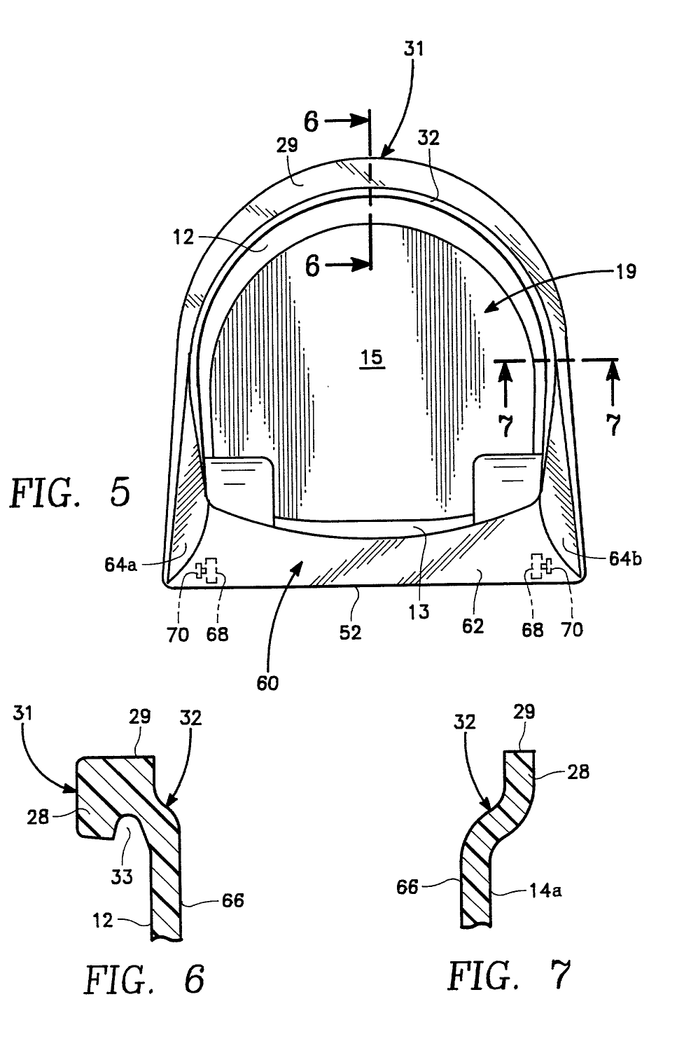

Referring to the Figures, the waste receptacle of the present invention is shown and is generally designated by reference character 10. The receptacle is defined by a front wall 12, a rear wall 13, opposing receptacle side walls 14a, 14b and a bottom 15. The front, rear and receptacle side walls extend upwardly and slightly outwardly from the bottom and are integrated with each other and of uniform thickness. The receptacle is preferably constructed of a high-density plastic material, but could also be constructed of fiberglass, metal, wood or resin laminate materials. The bottom has a somewhat circular overall shape when viewed in top plan, as best seen in FIG. 5, but could have other rounded or polygonal cross-sectional configurations.

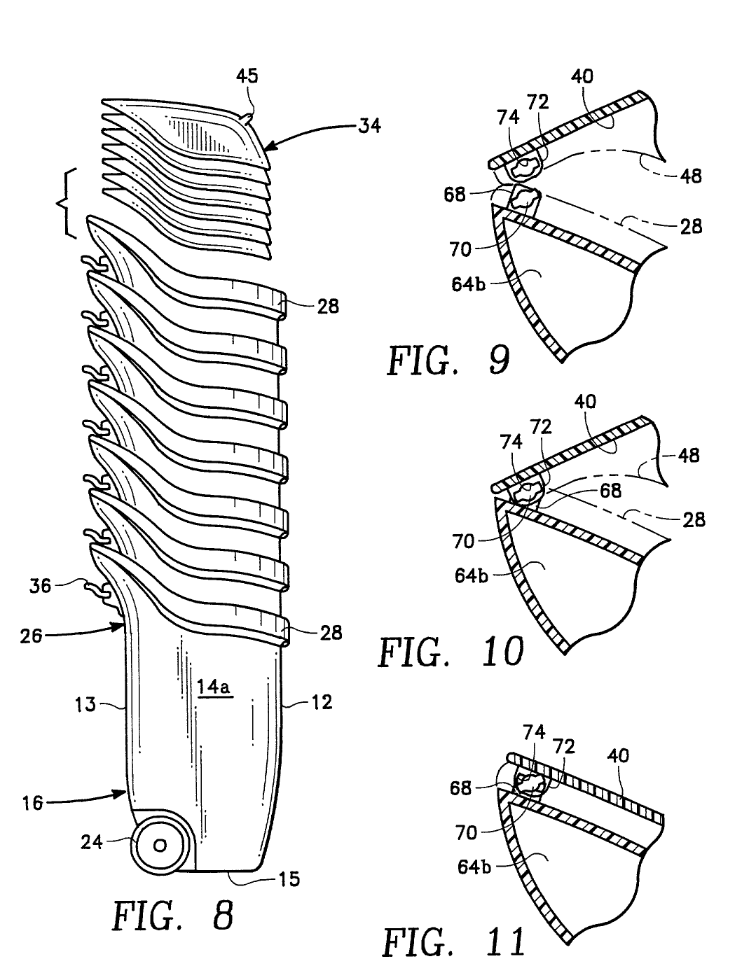

Rear wall 13 has a lower section 16 adjacent bottom 15. On each corner of the lower section is an outer recess 18 which extends upwardly from bottom 15 into the interior 19 of the receptacle, as best seen in FIGS. 4 and 5. The lower section further includes a center recess 20 which is about coextensive with outer recesses 18. As best seen in FIG. 4, an axle 22 is mounted to the receptacle and extends across the center recess, about parallel to bottom 14. The axle has sufficient length and is positioned so that opposing axle ends extend into a respective outer recess 18. A wheel 24 is rotatably attached to each respective axle end within a respective outer recess. Once attached, the wheels are substantially within the outer recesses and do not extend laterally past receptacle side walls 14a, 14b. This construction facilitates unencumbered stacking of the receptacles in a minimum of space, as shown in FIG. 8.

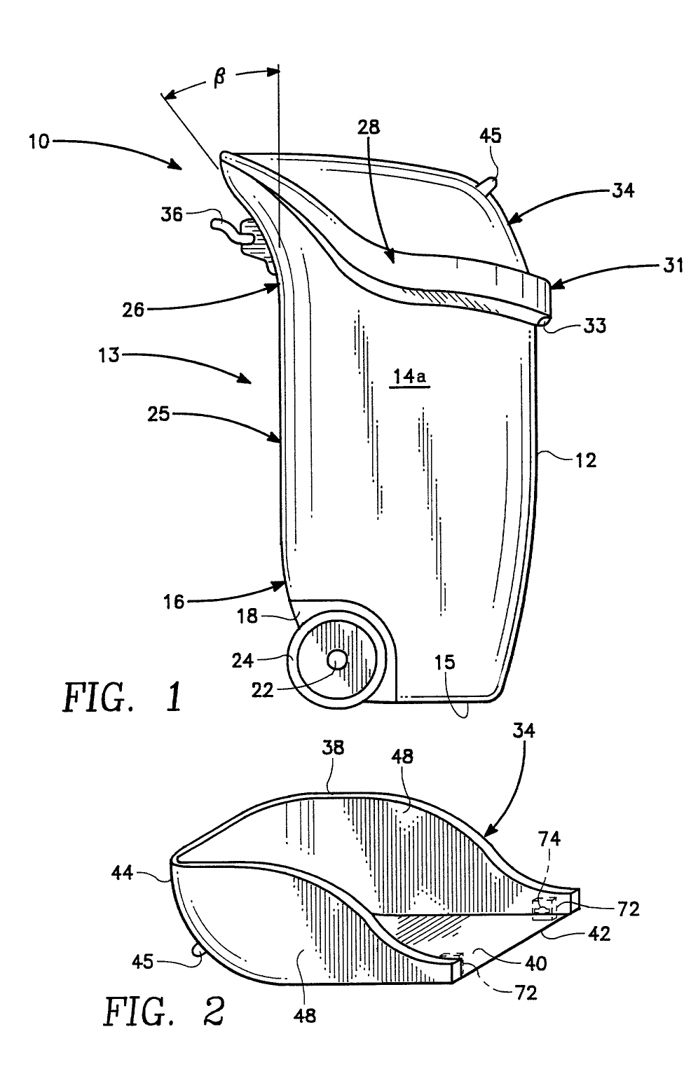

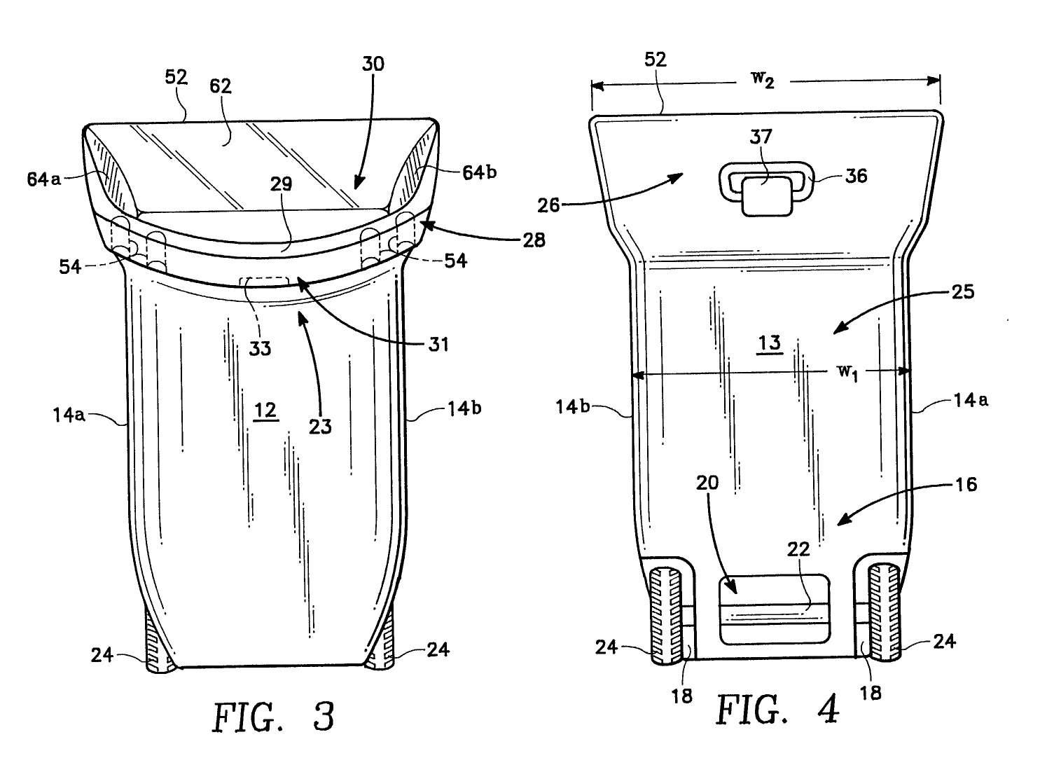

As stated above, the front, rear and receptacle side walls extend upwardly and slightly outwardly from the bottom and merge into a lip 28 which defines an open top area 30 (See FIG. 3). Enclosing the top area is lid 34, as shown in FIG. 1 (The structure of the lid is discussed in greater detail below).

The aforementioned lip has a top rim surface 29 and a thickened central portion 31 that extends across the uppermost front region 23 of front wall 12. The central portion provides reinforcement to the front wall and includes an undercut notch 33 (See FIGS. 3 and 6) for manually grasping the front of the receptacle. Vertical niches 54 can also be included in front region 23 of lip 28, as shown in FIG. 3. Various implements (not shown) can be selectively press-fit into the vertical niches to further facilitate convenient storage of and access to the implements as desired by the worker.

In a manner about coextensive with the plane of the forwardly inclined side walls 14a, 14b, the thicknesses of central portion 31 and rim surface 29 gradually diminish as they taper rearwardly and upwardly until they merge into respective corners of leading edge 52. This establishes a shovel portion 62 in the rear wall that has a dustpan-like configuration, as depicted in the FIGS. 3-5.

From lower section 16, rear wall 13 extends upwardly to a midsection 25 and then into an upper section 26. In the upper section, the rear wall flares outwardly at a predetermined angle β from the rear wall, as best seen in FIGS. 1, 3 and 5. Rear wall 13 also has an increasing taper from an initial transverse width w₁ at midsection 25 to a maximum transverse width w₂ in upper section 26 proximate leading edge 52. This structure further establishes a dustpan-like configuration for shovel portion 62.

The length of the leading edge is preferably at least about equal to the diameter of open top area 30. The width of the shovel portion is preferably at least about one fifth the open top area diameter. Such dimensions facilitate the collection and movement of debris into the receptacle interior 19 when the receptacle is tilted to place leading edge 52 against the ground (not shown in the Figures).

To further enhance debris movement, a pair of opposing side panels 64a, 64b extend upwardly from respective opposite ends of shovel portion 62 when leading edge 52 of shovel portion 62 is resting against the ground (not shown). The top edges of the side panels form outer extensions of rim surface 29. The inner portion of each side panel 64a, 64b merges into a respective receptacle side wall 14a, 14b and provides for a smooth transitional connection to the receptacle walls. The shovel portion and side panels cooperate to establish a trough 60 for the receptacle and further prevent debris from spilling from the shovel portion when the receptacle is resting against the ground and debris is being placed therein.

With reference to FIGS. 1 and 4, a pivot handle 36 is hingedly attached to a mounting bracket 37 which, in turn, is secured to the mid-portion of rear wall upper section 26. The handle acts in combination with the wheels to facilitate maneuvering of the receptacle. The mounting bracket can be mechanically attached to the receptacle, or it can be formed integral to the rear wall.

Because rear wall 13 flares outwardly at angle β as described, above, the overall depth of the bracket and handle is less than the depth of the inclination between upper section 26 and rear wall midsection 25 for a purpose to be described below. Stated differently, when the leading edge 52 of trough 60 is placed against the ground, handle 36 does not touch the ground and does not hinder movement of the receptacle.

The outward flare of rear wall 13 provides an additional advantage for the receptacle of the present invention. Specifically, the outward flare of rear wall 13 causes the receptacle to rest on three points when resting against the ground, leading edge 52 of trough 60 and the two wheels 24. This provides a stable configuration for the receptacle while debris is being placed therein during operation, yet allows for easy, unencumbered movement of the receptacle while tilted. This is accomplished by grasping the receptacle at undercut notch 33, and then lifting slightly and using the mechanical advantage provided by the wheels 24 to maneuver the receptacle.

Referring primarily to FIGS. 5-7, an inwardly directed shoulder 32 is offset downwardly a predetermined distance from rim surface 29 of lip 28. The shoulder provides an abutment support for lid 34. As shown is FIG. 5, the shoulder extends continuously around about one half the inner circumference of lip 28. However, the shoulder could comprise spaced-apart segments along the same circumference and still perform the same function. Because the shoulder projects toward the interior 19 of the receptacle, lid 34 will be located within lip 28 when placed thereon. The lid is sized to not increase the cross-sectional profile of the receptacle when seated on shoulder 32.

Referring now to FIG. 2, the structure of the lid is shown in greater detail. Specifically, the lid has a base 40 which presents a flat area that extends from front edge 42 rearwardly to an upturned rounded rear end portion 44. The front edge 42 has a width that is about equal to or less than the length of leading edge 52.

Extending upwardly from opposing side edges of the base are outwardly flared lid sidewalls 48. The lid sidewalls 48 have a minimal height proximate front edge 42, which increases rearwardly to a defined height. Then the sidewalls merge into the aforementioned rear end portion 44. With the above configuration, the lid comprises a scoop which is useful in gathering and loading debris (not shown) into the receptacle.

The lid sidewalls 48 are spaced-apart a distance about equal to the diameter of shoulder 32 and have an outline that conforms to the planar shape of the shoulder. The lid sidewalls 48 and rear end portion 44 terminate at an upper edge 38 that interfits with lip 28.

The lid is further formed with a knob 45 which projects outwardly from the upturned rounded rear end portion 44. Preferably, the knob is recessed into a hollow indented portion of the rear end portion. This will provide for more compact nesting of the lids as depicted in FIG. 8.

An alternative embodiment for the receptacle of the present invention is shown in FIGS. 2, 5 and 9-11. Specifically, an embodiment is shown wherein lid 34 is hingedly mounted to upper section 26 of rear wall 13. To do this, a pair of opposing lid pedestals 68 are attached to shovel portion 62 proximate side panels 64a, 64b (so that the dustpan-like advantages of the present invention are not obviated). A key post 70 is transversely mounted to each respect pedestal, as shown in FIG. 5.

Lid 34 includes pair of tabs 72 (shown in phantom in FIG. 2) that are attached to base 40 so that the tabs extend outwardly from base 40 in the same direction as lid side walls 48 and upturned rear end portion 44. The tabs are spaced-apart to correspond with the lateral distance between pedestals 68 on the receptacle. Each tab 72 is formed with a key opening 74 that is shaped to correspond with the shape of key post 70 (See FIGS. 9-11).

For assembly, lid 34 is maneuvered to align each of the key openings 74 of tabs 72 with a respective key post 70 of a pedestal 68. Next, key post 70 is inserted into key opening 74. The lid is then moved until upper edge 38 of lid 34 is engaged with shoulder 32 of receptacle 10 as described above. In this manner, lid 34 is hingedly attached to the receptacle in a manner which allows for selective removal by the worker, and/or dumping of receptacle by a waste truck while the lid is attached to the receptacle.

While the particular improved waste receptacle, as herein shown and disclosed in detail, is fully capable of obtaining the objects and providing the advantages above stated, it is to be understood that the presently preferred embodiments are merely illustrative of the invention. As such, no limitations are intended other than as defined in the appended claims.

What is claimed is:

1. A receptacle comprising:
a bottom from which extends a front wall, a rear wall and two side walls that, in combination, define an interior for said receptacle;
said rear wall having a lower section, a mid section and an upper section, said rear wall flaring rearwardly from said mid section to said upper section; and,
said rear wall being formed with a flat top portion in said upper section to establish a dustpan-like configuration for said top portion.

2. The receptacle of claim 1 wherein said rear wall has an increasing taper from a first transverse width at said midsection to a second width at said upper section, said second transverse width being greater than said first transverse width.

3. The receptacle of claim 2 wherein said upper section terminates at a beveled leading edge.

4. The receptacle of claim 1 wherein said receptacle includes a lip extending around said front wall and said receptacle side walls, said lip having a central portion with a decreasing taper from a maximum thickness at said front wall to a minimum thickness at said receptacle side walls.

5. The receptacle of claim 1 wherein said lip is formed with a shoulder extending into said interior from said lip.

6. The receptacle of claim 5 further comprising:
a lid removably attached to said receptacle;
said lid having a base, and further having at least one side wall and an upturned rear end portion that extends from said base to form a scoop-like configuration for said lid.

7. The receptacle of claim 6 wherein said receptacle side wall and said rear end portion engage said shoulder when said lid is attached to said receptacle.

8. The receptacle of claim 6 wherein said receptacle has an outer surface, wherein said lid has an outer lid surface and further comprising:
at least one pedestal projecting outwardly from said outer surface, said pedestal having a key post extending transversely therefrom; and,
at least one tab extending from said outer lid surface, said tab being formed with a tap opening for receiving said transverse post to hingedly attach said lid to said receptacle.

9. A receptacle comprising:
a bottom from which extends a front wall, a rear wall and two receptacle side walls that, in combination, define an open interior, said rear wall having an upper section from which extends a shovel portion with side panels for establishing a trough configuration.

10. The receptacle of claim 9 wherein said shovel portion flares outwardly from said upper section and includes a straight edge for engaging the ground when said rear wall is positioned adjacent the ground.

11. The receptacle of claim 9 further comprising a lip extending around said front wall and said receptacle side walls, said lip having a central portion with a decreasing taper from a maximum thickness at said front wall to a minimum thickness at said receptacle side walls.

12. The receptacle of claim 11 wherein said lip includes a shoulder projecting toward said interior from said inner surface.

13. The receptacle of claim 12 wherein said open interior is selectively enclosed with a removable lid having a scoop configuration.

14. The receptacle of claim 13 wherein said lid has a base, and further wherein said lid has at least one side wall and an upturned rear end portion that extend from said base to establish said scoop configuration for said lid.

15. The receptacle of claim 14 wherein said receptacle side wall and said rear end portion are engaged with said shoulder when said lid is attached to said receptacle.
said base having front edge with a minimum first width, said rear end portion having a maximum second width that is greater than said first width.

16. A method for moving debris into a receptacle which comprises the steps of:
tilting an upright receptacle until the receptacle rests against the ground, said receptacle having a bottom from which extends a front wall, a rear wall and two receptacle side walls that combine to define an open interior, said rear wall having an upper section from which extends a shovel portion with side panels for establishing a trough configuration, said rear wall being placed against the ground to engage said shovel portion against the ground;
sweeping the debris into said receptacle; and,
re-positioning said receptacle in an upright position.

17. The method of claim 16 wherein said receptacle includes a lip extending around said front wall and said receptacle side wall, and a lip extending around said front wall and said receptacle side walls, and further wherein said receptacle includes a lid resting on said lip, said lid having a base, at least one side wall and an upturned rear end portion that establish a scoop configuration for said lid, said method comprising the additional steps of:
removing said lid from said receptacle, said removing step occurring before said tilting step; and,
scooping the debris into said receptacle with said lid; and,
replacing said lid on said receptacle.
